(19) United States
(12) Patent Application Publication
(10) Pub. No.: US 2018/0044444 A1
(43) Pub. Date: Feb. 15, 2018

(54) OPTICAL COMPENSATION FILMS BASED ON STYRENIC FLUOROPOLYMER

(71) Applicant: Akron Polymer Systems, Inc., Akron, OH (US)

(72) Inventors: Dong Zhang, Uniontown, OH (US); Ted Germroth, Kingsport, TN (US); Thauming Kuo, Kingsport, TN (US); Xiaoliang Zheng, Hudson, OH (US); Chao Chen, Shanghai (CN); Peiyao Wang, Akron, OH (US); Lang Hu, Akron, OH (US); Wentao Li, Kingsport, TN (US); Alan Phillips, Johnson City, TN (US); Frank Harris, Boca Raton, FL (US)

(73) Assignee: Akron Polymer Systems, Inc., Akron, OH (US)

(21) Appl. No.: 15/675,237

(22) Filed: Aug. 11, 2017

Related U.S. Application Data
(60) Provisional application No. 62/374,247, filed on Aug. 12, 2016.

(51) Int. Cl. C08F 8/20; C08F 8/30; B32B 27/08; C09D 127/12

(52) U.S. Cl. CPC C08F 8/20; C09D 127/12; C08F 8/30; B32B 27/08; C08F 2500/26; B32B 2307/516; B32B 2307/518; B32B 2307/51; B32B 2307/418; B32B 2457/202; B32B 2457/206; B32B 2309/105

(57) ABSTRACT

Disclosed are optical compensation films with exceptionally high positive out-of-plane birefringence. The optical compensation films are based on substituted styrenic fluoropolymers and have positive out-of-plane bireftingence greater than 0.02 throughout the wavelength range of 400 nm<λ<800 nm. The optical compensation films of the invention are suitable for use in optical devices such as liquid crystal display (LCD) devices and organic light emitting diode (OLED) display devices.

### CROSS-REFERENCE TO RELATED APPLICATIONS

This application claims priority to and the benefit of U.S. Provisional Patent Application No. 62/374,247, filed Aug. 12, 2016, the entire content of which is incorporated by reference herein.

### FIELD

This invention relates to optical compensation films with exceptionally high positive out-of-plane birefringence. More specifically, this invention relates to optical compensation films based on substituted styrenic fluoropolymers having positive out-of-plane birefringence greater than 0.02 throughout the wavelength range of 400 nm<λ<800 nm. The optical compensation films of the invention are suitable for use in optical devices such as liquid crystal display (LCD) devices, organic light emitting diode (OLED) display devices, 3D glasses, optical switches, and waveguides where a controlled light management is desirable. More particularly, the optical compensation films of the present invention are for use in an in-plane switching LCD (IPS-LCD) and OLED display.

### BACKGROUND

U.S. Pat. No. 8,304,079 (the '079 patent) discloses a polymer film (a positive C-plate) having a positive out-of-plane birefringence greater than 0.002 throughout the wavelength range of 400 nm<λ<800 nm, wherein the film having been cast onto a substrate from a solution of a polymer having a moiety of

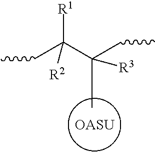

wherein R¹, R², and R³ are each independently hydrogen atoms, alkyl groups, substituted alkyl groups, or halogens, wherein OASU is a disk-like group or a mesogen, and wherein OASU is attached to the polymer backbone through a single covalent bond.

The most common polymer having a disk-like OASU is polystyrene, the solution-cast film of which generally has a birefringence of 0.001-0.002. It was disclosed in the '079 patent that the birefringence of polystyrene could be increased by incorporating a birefringence-enhancing substituent (BES) such as a bromo group or a nitro group onto the benzene ring. For example, poly(nitrostyrene) was reported to have a birefringence as high as about 0.016, and poly(bromostyrene) as high as about 0.007.

Additionally, U.S. Pat. No. 8,802,238 discloses that the birefringence of the polystyrene film can be greatly increased by incorporating fluorine atoms onto the backbone of the polystyrene molecule. Such a polymer film has a birefringence as high as about 0.015-0.02.

Although much has been achieved in increasing the birefringence of the styrenic polymer film, there remains a need for an even higher birefringence in the industry. For example, mobile devices based on OLED display technology have increasingly surpassed those based on LCD display technology. In an OLED device, a polarizer in combination with a quarter wave plate (QWP) is used to reduce the ambient light for improving viewing quality. The QWP used in the OLED configuration often has higher out-of-plane retardation needed for compensation than the A-plate used in the IPS-LCD configuration. Thus, there exists a need for a positive C-plate with exceptionally high out-of-plane birefringence to compensate the QWP used in an OLED configuration in order to optimize the image quality. Polymer films having a birefringence greater than 0.02 have been disclosed in U.S. Pat. No. 9,096,719. Such polymer films, however, require complicated synthesis schemes and thus are not cost effective for industrial applications. Optical compensation films based on styrenic polymers are especially desirable for their ease of manufacturing and cost effectiveness. Thus, styrenic polymers having a birefringence greater than 0.02 have been recognized as an ideal solution to fulfill this unmet need.

### SUMMARY

In one embodiment of the present invention, there is provided an optical compensation film composition comprising a positive birefringent polymer film and a substrate, wherein the polymer film is a positive C-plate and has a positive birefringence greater than 0.02 throughout the wavelength range of 400 nm<λ<800 nm, the film having been cast from a polymer solution comprising a solvent and a polymer having a moiety of:

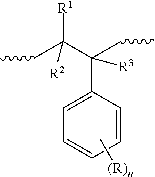

wherein R¹, R², and R³ are each independently hydrogen atoms, alkyl groups, substituted alkyl groups, or halogens, wherein at least one of R¹, R², and R³ is a fluorine atom. wherein R is each independently a substituent on the styrenic ring, and wherein n is an integer from 1 to 5 representing the number of the substituents on the styrenic ring.

In one embodiment of the present invention, a polymer resin is provided. The polymer resin has a styrenic moiety of:

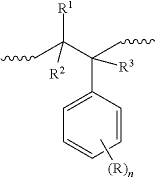

wherein R¹, R², and R³ are each independently hydrogen atoms, alkyl groups, substituted alkyl groups, or halogens, wherein at least one of R¹, R², and R³ is a fluorine atom, wherein R is each independently a substituent on the styrenic ring, and wherein n is an integer from 1 to 5 representing the number of the substituents on the styrenic ring.

In one embodiment of the present invention, a polymer solution is provided. The polymer solution comprises a solvent and a polymer having a styrenic moiety of:

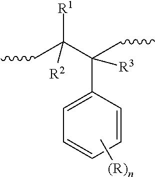

wherein R¹, R², and R³ are each independently hydrogen atoms, alkyl groups, substituted alkyl groups, or halogens, wherein at least one of R¹, R², and R³ is a fluorine atom, wherein R is each independently a substituent on the styrenic ring, and wherein n is an integer from 1 to 5 representing the number of the substituents on the styrenic ring.

### BRIEF DESCRIPTION OF THE DRAWINGS

The accompanying drawings, which are incorporated in and constitute a part of the specification, illustrate various example embodiments of aspects of the invention.

FIG. 1 is a graphical representation of the out-of-plane birefringence vs. degree of substitution (DS) of nitrated poly(α,β,β-trifluorostyrene) (PTFS) films;

FIG. 2 is a graphical representation of the refractive index vs. DS of nitrated PTFS films;

FIG. 3 is a graphical representation of the out-of-plane birefringence vs. DS of brominated PTFS films; and

FIG. 4 is a graphical representation of the refractive index vs. DS of brominated PTFS film.

### DETAILED DESCRIPTION

As is known in the art, the birefringence of a polymer film prepared by solution cast is dependent on the polymer's intrinsic birefringence and the order parameter upon film casting. The intrinsic birefringence depends on the chemical structure of the polymer, while the order parameter depends on the molecular orientation during film formation. Both of the intrinsic birefringence and the order parameter can be affected by the substituents on the backbone of the styrenic polymer as well as those on the phenyl ring. These substituents can also interact with each other, resulting in enhanced or reduced birefringence of the polymer film. Thus, it remains a challenge to discover a styrenic polymer that has an out-of-plane birefringence greater than 0.02,

In one embodiment of the present invention, there is provided an optical. compensation film composition comprising a positive birefringent polymer film and a substrate, wherein the polymer film is a positive C-plate and has a positive birefringence greater than 0.02 throughout the wavelength range of 40 nm<λ<800 nm, the film having been cast (i.e., onto the substrate) from a polymer solution comprising a solvent and a polymer having a moiety of:

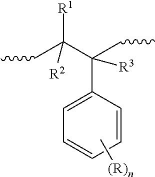

wherein R¹, R², and R³ are each independently hydrogen atoms, alkyl groups, substituted alkyl groups, or halogens, wherein at least one of R¹, R², and R³ is a fluorine atom, wherein R is each independently a substituent on the styrenic ring, and wherein n is an integer from 1 to 5 representing the number of the substituents on the styrenic ring.

In one embodiment of the present invention, a polymer resin is provided. The polymer resin has a styrenic moiety of:

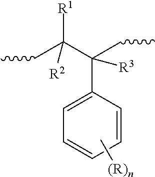

wherein R¹, R², and R³ are each independently hydrogen atoms, alkyl groups, substituted alkyl groups, or halogens, wherein at least one of R¹, R², and R³ is a fluorine atom, wherein R is each independently a substituent on the styrenic ring, and wherein n is an integer from 1 to 5 representing the number of the substituents on the styrenic ring.

In certain embodiments of the polymer resin, the substituent R on the styrenic ring is selected from one or more of the group consisting of alkyl, substituted alkyl, fluoro, chloro, bromo, iodo, hydroxyl, carboxyl, nitro, alkoxy, amino, sulfonate, phosphate, acyl, acyloxy, phenyl, alkoxycarbonyl, cyano, and trifluoromethyl. In certain embodiments of the polymer resin, the substituent R on the styrenic ring is selected from one or more of bromine (Br) and nitro (NO₂). In certain embodiments of the polymer resin, the substituent on the styrenic ring is and the degree of substitution (DS) of Br is greater than 1. In certain embodiments of the polymer resin, the substituent Ron the styrenic ring is Br, and the DS of Br is greater than 1.5. In certain embodiments of the polymer resin, the substituent R on the styrenic ring is Br, and the DS of Br is greater than 2. In certain embodiments of the polymer resin, the substituent Ron the styrenic ring is nitro, and the DS of nitro is greater than 0.25. In certain embodiments of the polymer resin, the substituent R on the styrenic ring is nitro, and the DS of nitro is greater than 0.4. In certain embodiments of the polymer resin, the substituent R on the styrenic ring is nitro, and the DS of nitro is greater than 0.6. In certain embodiments of the polymer resin, the substituent R on the styrenic ring is nitro, and the DS of nitro is greater than 0.8.

In one embodiment of the present invention, a polymer solution is provided. The polymer solution comprises a solvent and a polymer having a styrenic moiety of:

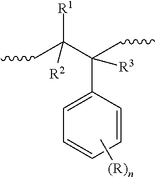

wherein R¹, R², and R³ are each independently hydrogen atoms, alkyl groups, substituted alkyl groups, or halogens, wherein at least one of R¹, R², and R³ is a fluorine atom, wherein R is each independently a substituent on the styrenic ring, and wherein n is an integer from 1 to 5 representing the number of the substituents on the styrenic ring.

In certain embodiments of the polymer solution, the solvent is selected from the group consisting of: toluene, methyl isobutyl ketone, cyclopentanone, methylene chloride, 1,2-dichloroethane, methyl amyl ketone, methyl ethyl ketone, methyl isoamyl ketone, and mixtures thereof. In certain embodiments of the polymer solution, the solvent is selected from the group consisting of: methyl ethyl ketone, methylene chloride, cyclopentanone, and mixtures thereof.

In certain embodiments of the polymer solution, the substituent R on the styrenic ring of the polymer is selected from one or more of the group consisting of alkyl, substituted alkyl, fluoro, chloro, bromo, iodo, hydroxyl, carboxyl, nitro, alkoxy, amino, sulfonate, phosphate, acyl, acyloxy, phenyl, alkoxycarbonyl, cyano, and trifluoromethyl. In certain embodiments of the polymer solution, the substituent R on the styrenic ring of the polymer is selected from one or more of bromine (Br) and nitro (NO₂). In certain embodiments of the polymer solution, the substituent on the styrenic ring of the polymer is Br, and the degree of substitution (DS) of Br is greater than 1. In certain embodiments of the polymer solution, the substituent R on the styrenic ring of the polymer is Br, and the DS of Br is greater than 1.5. In certain embodiments of the polymer solution, the substituent R on the styrenic ring of the polymer is Br, and the DS of Br is greater than 2. In certain embodiments of the polymer solution, the substituent R on the styrenic ring of the polymer is nitro, and the DS of nitro is greater than 0.25. In certain embodiments of the polymer solution, the substituent R on the styrenic ring of the polymer is nitro, and the DS of nitro is greater than 0.4. In certain embodiments of the polymer solution, the substituent R on the styrenic ring of the polymer is nitro, and the DS of nitro is greater than 0.6. In certain embodiments of the polymer solution, the substituent R on the styrenic ring of the polymer is nitro, and the DS of nitro is greater than 0.8.

The exemplary polymer resins and polymer solutions described herein may be used to form the exemplary positive birefringent polymer films exhibiting the properties described herein. For example, when a polymer resin according to the invention is combined with la solvent to form a polymer solution according to the invention, and the polymer solution is then solution-cast as a film onto a substrate, the polymer film formed from the polymer resin exhibits the properties in accordance with the exemplary polymer film embodiments disclosed herein.

The positive birefringent polymer film has a positive out-of-plane birefringence and is commonly referred to as positive C-plate. Positive out-of-plane birefringence (Δn) is defined as n_{z}>(nₓ+n_{y})/2, wherein nₓ and n_{y} represent in-plane refractive indices, and n_{z} represents the thickness-direction refractive index of the film (i.e., Δn=n_{z}(nₓ+n_{y})/2),

Birefringence (Δn) may be measured by determining the birefringence of a film over a wavelength range of about 400 nm to about 800 nm at different increments. Alternatively, birefringence of a film may be measured at 633 nm as is customary in the art. Reference to Δn at 633 nm is customary because birefringence at wavelengths less than 633 nm is generally higher than birefringence at 633 nm for a film with positive birefringence, and birefringence at wavelengths greater than 633 nm is generally the same as or slightly lower than birefringence at 633 nm. Thus, birefringence at 633 nm is understood in the art as indicating that birefringence throughout 400 nm<λ<800 nm is greater than or approximately the same as the birefringence at 633 nm.

As disclosed in U.S. Pat. No. 8,802,238, the birefringence of the poly(α,β,β-trifluorostyrene) (PTFS) film can be affected by the thickness of the film. When the thickness is below 2 μm, the birefringence of the film increases rapidly with decreasing thickness; whereas, when the thickness is above 2 μm, the birefringence of the film slowly decreases to a steady value with increasing thickness. The birefringences disclosed throughout this description are the value measured at the film thickness around 5 μm if not further specified.

In one aspect, at least two of R¹, R², and R³ are fluorine atoms. In another aspect, R¹, R², and R³ are all fluorine atoms.

Examples of the substituent R on the styrenic ring include one or more of alkyl, substituted alkyl, fluoro, chloro, bromo, iodo, hydroxyl, carboxyl, nitro, alkoxy, amino, sulfonate, phosphate, acyl, acyloxy, phenyl, alkoxycarbonyl, cyano, trifluoromethyl, and the like. In some embodiments, the substituent R is one or more selected from the group consisting of fluoro, chloro, bromo, iodo, nitro, phenyl, cyano, and trifluoromethyl. In another embodiment, the substituent R is nitro.

In one embodiment, the polymer solution is cast onto said substrate to form a polymer coating film on the substrate. The solution-cast polymer film is capable of forming an out-of-plane anisotropic alignment upon solvent evaporation without being subject to heat treatment, photo irradiation, or stretching, and has a positive birefringence greater than 0.02, greater than 0.021, greater than 0.022, greater than 0.023, greater than 0.025, greater than 0.027, greater than 0.028, greater than 0.029, greater than 0.03, greater than 0.031, greater than 0.032, greater than 0.033, greater than 0.034, greater than 0.035, or greater than 0.0358 throughout the wavelength range of 400 nm<λ<800 nm. In certain embodiments, the solution-cast polymer film has a positive birefringence of 0.02 to 0.2, including from 0.021 to 0.2, from 0.022. to 0.2, from 0.023 to 0.2, from 0.023 to 0.2, from 0.025 to 0.2, from 0,027 to 0.2. from 0.028 to 0.2, from 0.029 to 0.2, from 0.03 to 0.2, from 0.031 to 0.2, from 0.032 to 0.2, from 0.033 to 0.2, from 0.034 to 0.2, from 0.035 to 0.2, and from 0.0358 to 0.2 throughout the wavelength range of 400 nm<λ>800 nm.

In one aspect, the positive birefringent polymer film has a positive birefringence greater than 0.022 and the substituent R on the styrenic ring is one or more selected from bromine (Br) and nitro (NO₂). In another aspect, the positive birifringent polymer film has a positive birefringence greater than 0.027, greater than 0.03, or greater than 0.035 and the substituent R on the styrenic ring is nitro. In still another aspect, the positive birefringent polymer film has a positive birefringence greater than 0.023, greater than 0.025, greater than 0.028, or greater than 0.03 and the substituent R on the styrenic ring is Br. In another aspect, the positive birefringent polymer film has a positive birefringence of 0.027 to 0.05, from 0.03 to 0.05, or from 0.035 to 0.05 and the substituent R on the styrenic ring is nitro. In yet another aspect, the positive birefringent polymer film has a positive birefringence of 0.023 to 0.05, from 0.025 to 0.05, from 0.028 to 0.05, or from 0.03 to 0.05 and the substituent R. on the styrenic ring is Br.

The present inventors discovered that the birefringence of the polymer film can be tuned by changing the number of the substituents on the styrenic ring. In the polymer that is used to cast the polymer film, each styrenic moiety may or may not be substituted (but at least one is substituted); thus, the average number of the substituents on a styrenic moiety in the polymer can range from greater than 0 to 5, which is referred to herein as the degree of substitution (DS) of a substituent in a polymer.

For example, when the DS of Br is about 1, the birefringence of the polymer film is about 0.023; when the DS of Br is about 1.5, the birefringence is about 0.025; and when the DS of Br is about 2, the birefringence is about 0.028. When the DS of NO₂ is about 0.3, the birefringence is about 0.023; when the DS of NO₂ is about 0.45, the birefringence is about 0.027; when the DS of NO₂ is about 0.6, the birefringence is about 0.03; and when the DS of NO₂ is about 0.85, the birefringence is about 0.035.

Thus, in a further aspect, the positive birefringent polymer film has a positive birefringence greater than 0.023, the substituent R on the styrenic ring is Br, and the DS of Br is greater than 1. In another aspect, the positive birefringent polymer film has a positive birefringence greater than 0.025, the substituent Ron the styrenic ring is Br, and the DS of Br is greater than 1.5. In yet another aspect, the positive birefringent polymer film has a positive birefringence greater than 0.028, the substituent R on the styrenic ring is Br, and the DS of Br is greater than 2.

In a further aspect, the positive birefringent polymer film has a positive birefringence greater than 0.023, the substituent R on the styrenic ring is nitro, and the DS of nitro is greater than 0.25. In another aspect, the positive birefringent polymer film has a positive birefringence greater than 0.027, the substituent R on the styrenic ring is nitro, and the DS of nitro is greater than 0.4. In another aspect, the positive birefringent polymer film has a positive birefringence greater than 0.03, the substituent R on the styrenic ring is nitro, and the DS of nitro is greater than 0.6. In another aspect, the positive birefringent polymer film has a positive birefringence greater than 0.035, the substituent R on the styrenic ring is nitro, and the DS of nitro is greater than 0.8.

The casting of a polymer solution onto a substrate may be carried out by a method known in the art such as, for example, spin coating, spray coating, roll coating, curtain coating, or dip coating. Substrates are known in the art, non-limiting examples of which include triacetyl cellulose (TAC), cyclic olefin polymer (COP), polyester, polyvinyl alcohol, cellulose ester, cellulose acetate propionate (CAP), polycarbonate, polyacrylate, polyolefin, polyurethane, polystyrene, glass, and other materials commonly used in an LCD or OLED device.

In another embodiment of this invention, the polymer is soluble in a solvent such as toluene, methyl isobutyl ketone, cyclopentanone, methylene chloride, 1,2-dichloroethane, methyl amyl ketone, methyl ethyl ketone, methyl isoamyl ketone, and mixtures thereof.

The polymer used for the preparation of the optical compensation film composition of the present invention comprises a styrenic moiety having a substituent R. The substituent may be incorporated onto the styrenic ring by using a substituted fluorine-containing monomer (1) having the structure below:

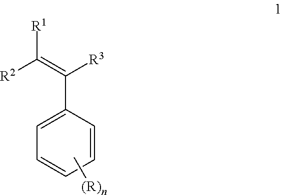

wherein R¹, R², and R³ are each independently hydrogen atoms, alkyl groups, substituted alkyl groups, or halogens and wherein at least one of R¹, R², and R³ is a fluorine atom, wherein R is a substituent on the styrenic ring, and wherein n is an integer from 1 to 5 representing the number of the substituents on the styrenic ring. Examples of substituted fluorine-containing monomers include, but are not limited to, substituted α,β,β-trifluorostyrene having one or more substituents on the styrenic ring, such as, for example, α,β,β-trifluoro-4-chloro-styrene, α,β,β-trifluoro-4-nitro-styrene and α,β,β-trifluoro-4-bromo-styrene.

The substituent can also be incorporated onto the styrenic ring by post-reacting a styrenic fluoropolymer with a reagent that can yield the desirable substituent on the styrenic ring. By using this method, the number of the substituent(s) on each styrenic ring is random and the degree of substitution (DS) disclosed herein is an average number of the substituent(s) on a styrenic ring. Examples of such styrenic fluoropolymers include, but are not limited to, poly(αβ,β-trifluorostyrene), poly(α,β-difluorostyrene), poly(β,β-difluorostyrene), poly (α-fluorostyrene), and poly(β-fluorostyrene). In one embodiment the fluoropolymer is poly(α,β,β-trifluorostyrene).

The polymer film of the present invention may be a homopolymer or a copolymer. The homopolymer may be prepared by polymerization of a substituted fluorine-containing monomer (1). The copolymer may be prepared by copolymerization of one or more of the substituted fluorine-containing monomers with one or more of ethylenically unsaturated monomers. Examples of ethylenically unsaturated monomers include, but are not limited to, α,β,β-trifluorostyrene, α,β-difluorostyrene, β,β-difluorostyrene, α-fluorostyrene, β-fluorostyrene, methyl acrylate, methyl methacrylate, ethyl acrylate, ethyl methacrylate, butyl acrylate, butyl methacrylate, isobutyl acrylate, isobutyl methacrylate, ethylhexyl acrylate, 2-ethylhexyl methacrylate, 2-ethylthexyl acrylate, isoprene, octyl acrylate, octyl methacrylate, iso-octyl acrylate, iso-octyl methacrylate, trimethyolpropyl triacrylate, styrene, α-methyl styrene, nitrostyrene, bromostyrene, iodostyrene, cyanostyrene, chlorostyrene, 4-t-butylstyrene, 4-methylstyrene, vinyl biphenyl, vinyl triphenyl, vinyl toluene, chloromethyl styrene, acrylic acid, methacrylic acid, itaconic acid, crotonic acid, maleic anhydride, tetrafluoroethylene (and other fluoroethylenes), glycidyl methacrylate, carbodiimide methacrylate, C1-C18 alkyl crotonates, di-n-butyl maleate, di-octylmaleate, allyl methacrylate, di-allyl maleate, di-allylmalonate, methyoxybutenyl methacrylate, isobornyl methacrylate, hydroxybutenyl methacrylate, hydroxyethyl(meth)acrylate, hydroxypropyl(meth)acrylate, acetoacetoxy ethyl methacrylate, acetoacetoxy ethyl acrylate, acrylonitrile, vinyl chloride, vinylidene chloride, vinyl acetate, vinyl ethylene carbonate, epoxy butene, 3,4-dihydroxybutene, hydroxyethyl(meth)acrylate, methacrylamide, acrylamide, butyl acrylamide, ethyl acrylamide, diacetoneacrylamide, butadiene, vinyl ester monomers, vinyl(meth)acrylates, isopropenyl(meth)acrylate, cycloaliphaticepoxy(meth)acrylates, ethylformamide, 4-vinyl-1,3-dioxolan-2-one, 2,2-dimethyl-vinyl-1,3-dioxolane, 3,4-di-acetoxy-1-butene, monovinyl adipate, t-butylaminoethyl methacrylate, dimethylaininoethyl methacrylate, diethylaminoethyl methacrylate, N,N-dimethyl aminopropyl methacrylamide, 2-t-butyl aminoethyl methacrylate, N,N-dimethylaminoethyl acrylate, N-(2-methacryloyloxy-ethyl)ethylene urea, and methacrylamido-ethylethylene urea. Further monomers are described in The Brandon Associates, 2nd edition, 1992 Merrimack, N.H., and in Polymers and Monomers, the 1996-1997 Catalog from Polysciences, Inc., Warrington, Pa., U.S.A.

In one embodiment, the polymer is a copolymer of substituted α,β,β-trifluorostyrene with one or more ethylenically unsaturated monomers selected from the group consisting of α,β,β-trifluorostyrene, α,β-difluorostyrene, β,β-difluorostyrene, α-fluorostyrene, β-fluorostyrene, styrene, methyl acrylate, methyl methacrylate, butyl acrylate, butyl methacrylate, 2-ethylhexyl acrylate, acrylic acid, methacrylic acid, α-methyl styrene, 4-methylstyrene, vinyl biphenyl, acrylonitrile, and isoprene.

Polymerization may be carried out by a method known in the art such as bulk, solution, emulsion, or suspension polymerization. The reaction may be free radical, cationic, anionic, zwitterionic, Ziegler-Natta, or atom transfer radical type of polymerization. Emulsion polymerization is one method of polymerization when a particularly high molecular weight is desirable. A high molecular weight polymer may lead to better film quality and higher positive birefringence. Methods for the preparation of homopolymers and copolymers of monofluoro-, difluoro-, and trifluorostyrene can be found in Progress in Polymer Science, Volume 29 (2004), pages 75-106, Elsevier Ltd., MO, USA, the content of which is incorporated herein by reference.

In addition to the aforementioned fluoromonomers (i.e., the fluoromonomers of formula 1), other fluoromonomers, such as the fluoromonomers of formulae 2 to 7 shown below, are also suitable for this invention.

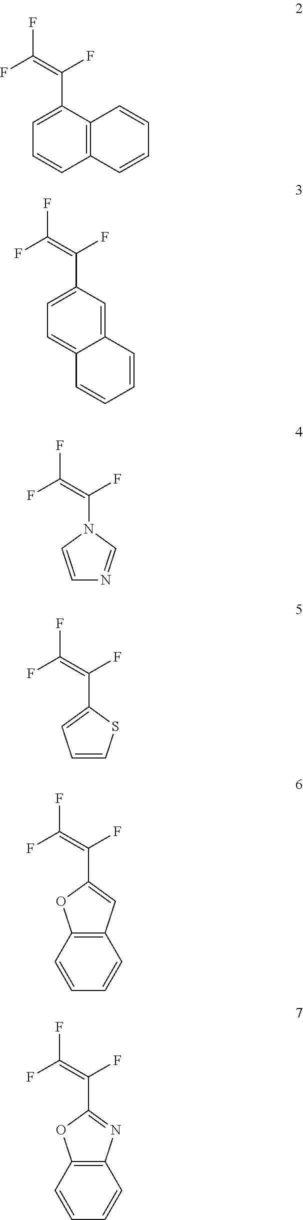

Thus, this invention further provides an optical compensation film composition comprising a positive birefringent polymer film and a substrate, wherein the polymer film is a positive C-plate and has a positive birefringence greater than 0.02 throughout the wavelength range of 400 nm<λ<800 nm. In one embodiment, the film is cast onto a substrate from a polymer solution including a solvent and a polymer, said polymer having one or more moieties selected from formulae 8 to 13:

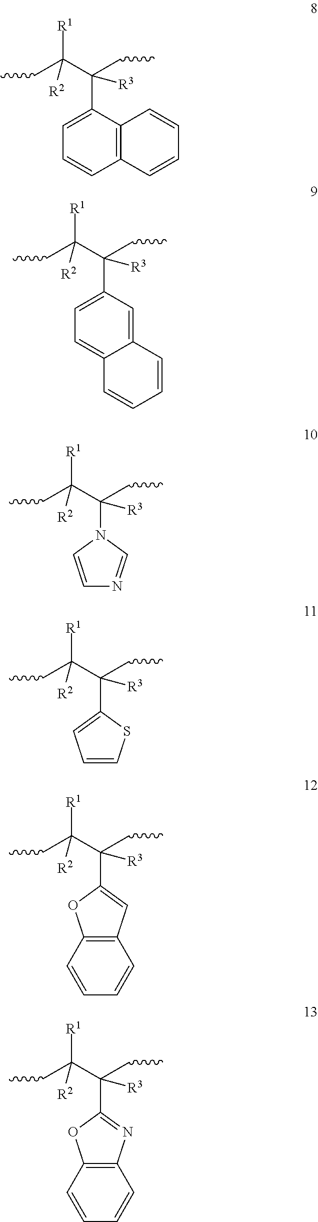

wherein R¹, R², and R³ are each independently hydrogen atoms, alkyl groups, substituted alkyl groups, or halogens, and wherein at least one of R¹, R², and R³ is a fluorine atom. Polymers having one or more such moieties are denoted as vinyl aromatic fluoropolymers throughout the description of this invention. The vinyl aromatic fluoropolymers may have one or more substituents on their aromatic rings. Examples of the substituents include one or more of alkyl, substituted alkyl, fluoro, chloro, bromo, iodo, hydroxyl, carboxyl, nitro, alkoxy, amino, sulfonate, phosphate, acyl, acyloxy, phenyl, alkoxycarbonyl, cyano, trifluoromethyl, and the like. In some embodiments, the substituent(s) on the aromatic rings of the vinyl aromatic fluoropolymers is selected from the group consisting of fluoro, chloro, bromo, iodo, nitro, phenyl, cyano, trifluoromethyl, and combinations thereof. In another embodiment, the substituent(s) on the aromatic rings of the vinyl aromatic fluoropolymers is nitro.

Solution film casting may be done with a substituted styrenic fluoropolymer solution or a solution comprising a blend of the fluoropolymer and other polymers. Polymer solutions may further contain other additives such as plasticizers. Plasticizers are common additives used for film formation to improve film properties.

Examples of the plasticizers suitable for this invention include those available from Eastman Chemical Company (Kingsport, Tenn.): Abitol E (hydrogenated gum rosin), Permalyn 3100 (tall oil rosin ester of pentaerythritol), Permalyn 2085 (tall oil rosin ester of glycerol), Permalyn 6110 (gum rosin ester of pentaerythritol), Foralyn 110 (hydrogenated gum rosin ester of pentaerythritol), Admex 523 (a dibasic acid glycol polyester), and Optifilm Enhancer 400 (a proprietary low VOC, low odor coalescent); those available from Unitex Chemical Corp. (Greensboro, N.C.): Uniplex 552 (pentaerythritol tetrabenzoate), Uniplex 280 (sucrose benzoate), and Uniplex 809 (PEG di-2-ethylhexoa.te); triphenylphosphate, tri(ethylene glycol)bis(2-ethylhexanoate), tri(ethylene glycol)bis(n-.octanoate), and mixtures thereof.

In another embodiment, the polymer solution further comprises one or more of the plasticizers selected from the group consisting of triphenylphosphate, tri(ethylene glycol)bis(2-ethylhexanoate), tri(ethylene glycol)bis(n-octanoate); Optifilm Enhancer 400, Abitol E, and Admex 523 available from Eastman Chemical Company (Kingsport, Tenn.); Uniplex 552, Uniplex 809, and Uniplex 280 available from Unitex Chemical Corp. (Greensboro, N.C.).

Depending on the composition, the polymer of the present invention may be soluble in, for example, toluene, methyl isobutyl ketone, cyclopentanone, methylene chloride, 1,2-dichloroethane, methyl amyl ketone, methyl ethyl ketone, methyl isoamyl ketone, or mixtures thereof.

A unique feature of the present invention is the high out-of-plane birefringence (Δn=n_{z}−(nₓ+n_{y})/2) of the film resulting from solution cast of a substituted styrenic fluoropolymer. This allows for the casting of a thin coating film onto a substrate to yield a compensation film having a desirable out-of-plane retardation (Rₜₕ). As is commonly known in the art, the retardation of an optical film is defined as R=Δn×d, wherein d is the thickness of the film. In one embodiment, the thickness of a coating on a substrate for optical film applications is about 1-15 μm (including, but not limited to, 1 μm, 2 μm, 3 μm, 4 μm, 5 μm, 6 μm, 7 μm, 8 μm, 9 μm, 10 μm, 11 μm, 12 μm, 13 μm, 14 μm, or 15 μm), and in another embodiment, the thickness of a coating on a substrate is about 1-12 μm.

A birefringent polymer film may have an out-of-plane retardation, Rₜₕ=(n_{z}−(nₓ+n_{y})/2)×d, in the thickness direction and/or in-plane retardation, Rₑ=(nₓ−n_{y})×d, wherein nₓ and n_{y} represent in-plane refractive indices, and n_{z} represents the thickness-direction refractive index of the film. The polymer film of the present invention has Rₜₕ>0 and |Rₑ| is close to zero, for example, less than 10 nm, preferably less than 5 nm, and more preferably less than 2 nm. Such a polymer film is often referred to as positive C-plate. One of the optical compensation film configurations for IPS-LCD is to have a positive C-plate (refractive index profile: n_{z}>nₓ=n_{y}) coated on a positive A-plate (nₓ>n_{y}=n_{z}). In such a configuration, Rₜₕ for the C-plate is about 60 nm to about 150 nm, Rₑ for the A-plate is about 50 nm to about 200 nm, and the thickness of the C-plate is about 1-8 μm.

Thus, in another embodiment, this invention provides an optical compensation film composition comprising a polymer film having an out-of-plane retardation (Rₜₕ) of about 60 nm to about 150 nm, the film having been solution-cast onto a substrate which is an A-plate having a refractive index profile nₓ>n_{y}=n_{z} and in-plane retardation (Rₑ) of about 50 nm to about 200 nm, wherein the coating has a thickness of about 1-8 μm (including, but not limited to, 1 μm, 2 μm, 3 μm, 4 μm, 5 μm, 6 μm, 7 μm, or 8 μm). Examples of such a substrate include stretched COP film and stretched polycarbonate film.

Another optical compensation film configuration for IPS-LCD is to have a positive C-plate coated on a biaxial film (nₓ>n_{y}>n_{z}). In such a configuration, the Rₜₕ for the C-plate is about 60 nm to about 250 nm and the retardations for the biaxial film are an Rₑ of about 60 nm to 200 nm and an Rₜₕ of about −100 nm to −200 nm.

Thus, in another embodiment, this invention provides an optical compensation film composition comprising a polymer film having an out-of-plane retardation (Rₜₕ) of about 60 nm to about 250 nm, the film having been solution cast onto a substrate which is a biaxial film having a refractive index profile nₓ>n_{y}>n_{z}, in-plane retardation (Rₑ) of about 60 nm to about 200 nm, and an out-of-plane retardation (Rₜₕ) of about −100 nm to about −200 nm, wherein the coating has a thickness of about 1 μm to about 12 μm. Examples of such a substrate include stretched cellulose ester films such as CAP and TAC films and stretched polyimide films.

In the above two configurations, the polymer film of the present invention is solution cast onto stretched films of, for example, COP, polycarbonate, TAC, and CAP to obtain the desired combinations of Rₜₕ and Rₑ. Alternatively, the polymer film may be cast onto unstretched films of said materials; the resulting coated substrates can then be stretched to the specified overall Rₜₕ and Rₑ values.

In another embodiment, the polymer film of the present invention is stretched to yield a biaxial film having a refractive index profile of nₓ<n_{y}<n_{z}, or a negative A-plate having nₓ<n_{y}=n_{z}. Methods for the preparation of such films are disclosed in U.S. Pat. No. 8,889,043, the content of which is incorporated herein by reference.

In another embodiment, the compensation film is used in a liquid crystal display device including an in-plane switching liquid crystal display device. The liquid crystal display device may be used as a screen for a mobile phone, tablet, computer, or television.

In an OLED device, a polarizer in combination with a quarter wave plate (QWP) is used to reduce the ambient light. The QWP used in the OLED configuration often has a higher out-of-plane retardation needed for compensation than the A-plate used in the IPS-LCD configuration.

A quarter wave plate (QWP) has an in-plane retardation (Rₑ) equal to a quarter of a light wavelength (λ), Rₑ=λ/4. The QWP may be a broadband QWP having an Rₑ equal to about λ/4 at each wavelength ranging from about 400 nm to about 800 nm. Examples of such a QWP include, but are not limited to, stretched COP film and stretched polycarbonate film. QWP is typically an A-plate with an Rₑ of about 100 nm to about 200 nm and an Rₜₕ of about −60 nm to about −100 nm; however, a QWP can also be a biaxial film with an Rₑ of about 100 nm to about 200 and an Rₜₕ of about −50 nm to about −150 nm.

Thus, in another embodiment, this invention provides an optical compensation film composition comprising a polymer film having an out-of-plane retardation (Rₜₕ) of about 60 nm to about 300 nm, the film having been solution cast onto a substrate which is a QWP having a refractive index profile nₓ>n_{y}>n_{z}, an in-plane retardation (Rₑ) of about 100 nm to about 200 nm, and an out-of-plane retardation (Rₜₕ) of about −50 nm to about −150 nm, wherein the coating has a thickness of about 1 μm to about 12 μm. Examples of such a substrate include, but are not limited to, a stretched COP film and a stretched polycarbonate film.

In a further embodiment, there is provided an optical compensation film composition comprising the positive birefringence polymer film of this invention and a quarter wave plate (QWP), the polymer film having been solution cast onto the QWP, wherein the optical compensation film composition has an in-plane retardation (Rₑ) of about 100 nm to about 200 nm and an out-of-plane retardation (Rₜₕ) that satisfies the equation of |Rₜₕ|<100 nm, or |Rₜₕ|50 nm, or |Rₜₕ|<30 nm, or |Rₜₕ|<10 nm, or |Rₜₕ|<5 nm throughout the wavelength range of about 400 nm to about 800 nm, and the coating has a thickness of about 1 μm to about 12 μm.

The QWP coated with the positive birefringence polymer film of this invention may be combined with a linear polarizer to yield a circular polarizer. Thus, this invention further provides a circular polarizer comprising a linear polarizer and a coated QWP of the present invention, wherein the coated QWP has a refractive index profile nₓ>n_{y}≧n_{z} and an out-of-plane retardation (Rₜₕ) of about 50 nm to about 150 nm, and wherein the coating has an out-of-plane retardation (Rₜₕ) of about 60 nm to about 150 nm and a thickness of about 1-8 μm. In another embodiment, there is provided an OLED display comprising a circular polarizer of the present invention. The circular polarizer can also be used for 3D glasses.

In another embodiment, the compensation film is used in an OLED display device. The OLED display device may be used as a screen for a mobile phone, tablet, computer, or television.

In another embodiment, the solution-cast polymer film is removed from the substrate upon drying to yield a free-standing film, which may be uniaxially or biaxially stretched. The free-standing film may be attached to a substrate by lamination.

The solution-cast fluoropolymer film may be further stretched uniaxially or biaxially by a method known in the art to yield an in-plane birefringence satisfying the equation of |nₓ−n_{y}|>0.001, wherein nₓ and n_{y} are in-plane refractive indices of the film. Stretching can be done by using either a free-standing film or a film on a carrier substrate. The stretched fluoropolymer film thus obtained can then be laminated to a wave plate by itself or with the substrate, which is subsequently removed.

### EXAMPLES

The following examples describe and demonstrate exemplary embodiments of the polymers, polymer solutions, polymer films, and methods described herein. The exemplary embodiments are provided solely for the purpose of illustration and are not to be construed as limitations of the present disclosure, as many variations thereof are possible without departing from the spirit and scope of the present disclosure.

### Example 1. Polymer Film Preparation and Birefringence Measurement

A sample of a substituted styrenic fluoropolymer was dissolved in a suitable solvent such as, for example, methylene chloride at 7 weight % or methyl ethyl ketone at 12 weight %. The solution was applied to a flat glass substrate using the blade casting method with a desired gap, for example, a gap of 4 mils (100 μm). The film was allowed to dry in air overnight and subsequently placed in a vacuum oven at 80° C. for 8 hours. After drying, the film was peeled off. Birefringence of the free standing polymer film was measured by a Metricon Model 2010/M Prism Coupler using single film mode at the wavelength of 633 nm.

### Example 2. Synthesis of Nitrated Poly(α,β,β-trifluorostyrene) (PTFS) Having Various Degrees of Substitution (Polymer 1)

Materials: poly(α,β,β-trifluorostyrene) (PTFS) was an internal product with an intrinsic viscosity (IV) of 1.10 dL/g, used as received. Dichloromethane (DCM) was from Acros, purified by passing through SiO₂. HNO₃ was from Acros (68%-70%), used as received. H₂SO₄ was from Sigma Aldrich (95.0%-98.0%), used as received. Fuming H₂SO₄ was from Alfa Aesar (18%-24% free SO₃), used as received.

To a one-liter three-neck round-bottom flask equipped with nitrogen inlet/outlet and a mechanical stirrer was charged a solution (200 g, 5 weight %) of PTFS (IV, 1.10 dL/g) in dichloromethane (DCM). Separately, a mixed acid solution was prepared by adding concentrated sulfuric add (1.64 g) to nitric acid (13.6 g). The flask was placed in a water bath at room temperature. To the stirred PTFS solution in the flask was added the mixed acid over a period of 10 minutes. The reaction mixture was allowed to react at room temperature for 21 hours and subsequently quenched by adding deionized water/ice (450 ml), The water phase at the top was then decanted and the organic phase washed repeatedly with deionized water to remove the acids. The resulting organic layer was precipitated into methanol (about one liter) and grounded in a high speed blender to yield a powder suspension. The powder was then filtered and washed repeatedly with water and methanol. The resulting product was dried at 80° C. under reduced pressure overnight. Intrinsic viscosity (IV) of the polymer was 1.20 dL/g, measured by a Cannon® auto capillary viscometer using N-methyl-2-pyrrolidone (NMP) as the solvent at 30° C. The degree of substitution (DS) of the nitro group in the product was determined to be 0.27 by elemental analysis (EA).

By using the same method, nitrated PTFS polymers (Polymers 1-6) having various degrees of substitution (DS) were prepared as listed in Table 1.

TABLE 1
Synthesis of Nitrated PTFS Having Various Degrees of Substitution

| | PTFS, | DCM, | 69% | H₂SO₄, | Yield, | | DS from |
|---|---|---|---|---|---|---|---|
| ID | g | g | HNO₃, g | g | g | IV, dL/g | EA |
| Polymer 1 | 10.00 | 190.0 | 1.64 | 13.6 | 10.65 | 1.20 | 0.27 |
| Polymer 2 | 19.07 | 360.9 | 5.53 | 44.0 | 20.25 | 1.21 | 0.47 |
| Polymer 3 | 17.39 | 328.9 | 10.08 | 43.7 | 19.11 | 1.19 | 0.62 |
| Polymer 4 | 15.31 | 289.6 | 17.64 | 44.6 | 17.21 | 1.15 | 0.68 |
| Polymer 5 | 16.17 | 306.0 | 27.81 | 70.6 | 16.65 | 1.20 | 0.86 |
| Polymer 6 | 15.97 | 302.1 | 18.84 | 124.8 | 18.20 | 1.18 | 0.92 |
| | | | | (Fuming) | | | |

### Example 3. Optical Properties of Nitrated PTFS Films Having Various Degrees of Substitution

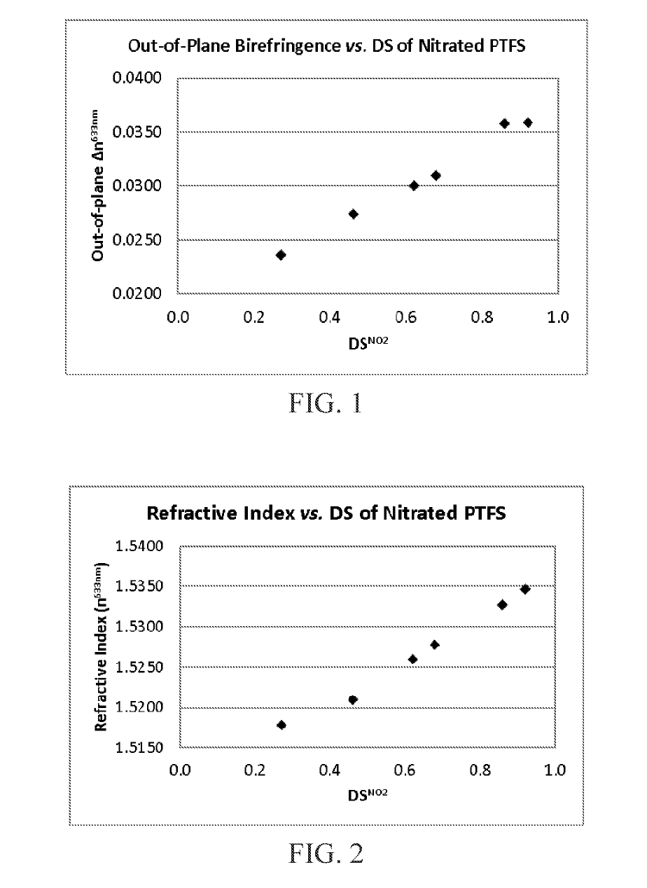

Films 1-6 in Table 2 were thin films prepared from polymers in Table 1 (Polymers 1-6), using MEK as the casting solvent. All films were controlled at the thickness of 4.0-5.0 μm for comparison. Based on the results in Table 2, the birefringence and the refractive index were plotted respectively against the degree of substitution in FIG. 1 and FIG. 2, where the two properties increase with increasing DS.

TABLE 2
Optical Properties of Nitrated PTFS Films Having Various
Degrees of Substitution

| | | IV, | Casting | | | Thickness, |
|---|---|---|---|---|---|---|
| ID | DS^{NO2} | dL/g | Solvent | n^{633 nm} | Δn^{633 nm} | μm |
| Film 1 | 0.27 | 1.20 | MEK | 1.5178 | 0.0236 | 4.9 |
| Film 2 | 0.47 | 1.21 | MEK | 1.5210 | 0.0274 | 4.3 |
| Film 3 | 0.62 | 1.19 | MEK | 1.5260 | 0.0300 | 4.5 |
| Film 4 | 0.68 | 1.15 | MEK | 1.5278 | 0.0310 | 4.0 |
| Film 5 | 0.86 | 1.20 | MEK | 1.5327 | 0.0358 | 4.0 |
| Film 6 | 0.92 | 1.18 | MEK | 1.5347 | 0.0359 | 5.0 |

### Example 4. Synthesis of Brominated Poly(α,β,β-trifluorostyrene) (PTFS) Having Various Degrees of Substitution (Polymer 7)

Materials: Poly(α,β,β-trifluorostyrene) (PTFS) had an IV 1.10 dL/g or 2.83 dL/g. Dichloromethane (DCM) was from Acros, purified by passing through SiO₂. 1,3-dibromo-5,5-dimethylhydantoin (DBMH) was from Sigma Aldrich (98%), used as received. CF₃SO₃H was from Alfa Aesar (98+%), used as received.

To a 250 ml, three-neck round-bottom flask equipped with nitrogen inlet/outlet and a mechanical stirrer were charged a solution of PTFS (8.00 g; IV, 1.10 dL/g) in dichloromethane (100 mL), CF₃SO₃H (7.550 g), and 1,3-dibromo-5,5-dimethylhydantoin (DBMH) (7.222 g). The mixture was stirred to form a homogeneous solution and the flask was subsequently placed in a water bath at 30° C. The stirring was allowed to continue for 24 hours. The resulting mixture was then precipitated into methanol to yield a fibrous crude product, which was filtered and washed repeatedly with water and methanol. The purified product was dried at 80° C. under reduced pressure overnight. Yield: 11.69 g. Intrinsic viscosity (IV) of the polymer was 1.13 dL/g as measured by a Cannon® auto capillary viscometer using N-methyl-2-pyrrolidone (NMP) as the solvent at 30° C.

By using the same method, brominated PTFS polymers (Polymers 7-11) having various degrees of substitution (DS) were prepared as listed in Table 3. Polymers 7, 9 and 10 were from PTFS with an IV of 1.10 dL/g, while Polymers 8 and 11 were from PTFS with an IV of 2.83 dL/g.

TABLE 3
Synthesis of Brominated PTFS Having Various Degrees of Substitution

| | PTFS, | | | CF₃SO₃H, | Yield, | | DS |
|---|---|---|---|---|---|---|---|
| ID | g | DCM, ml | DBMH, g | g | g | IV dL/g | (Target) |
| Polymer 7 | 8.000 | 100.0 | 7.222 | 7.550 | 11.690 | 1.13 | 1.0 |
| Polymer 8 | 4.000 | 80.0 | 3.623 | 3.737 | 5.885 | 2.47 | 1.0 |
| Polymer 9 | 4.000 | 50.0 | 5.435 | 5.639 | 6.788 | 0.96 | 1.5 |
| Polymer 10 | 4.683 | 70.0 | 8.468 | 8.893 | 8.918 | 1.07 | 2.0 |
| Polymer 11 | 4.360 | 86.0 | 7.884 | 8.307 | 8.235 | 1.72 | 2.0 |

### Example 5. Optical Properties of Brominated PTFS Films Having Various Degrees of Substitution

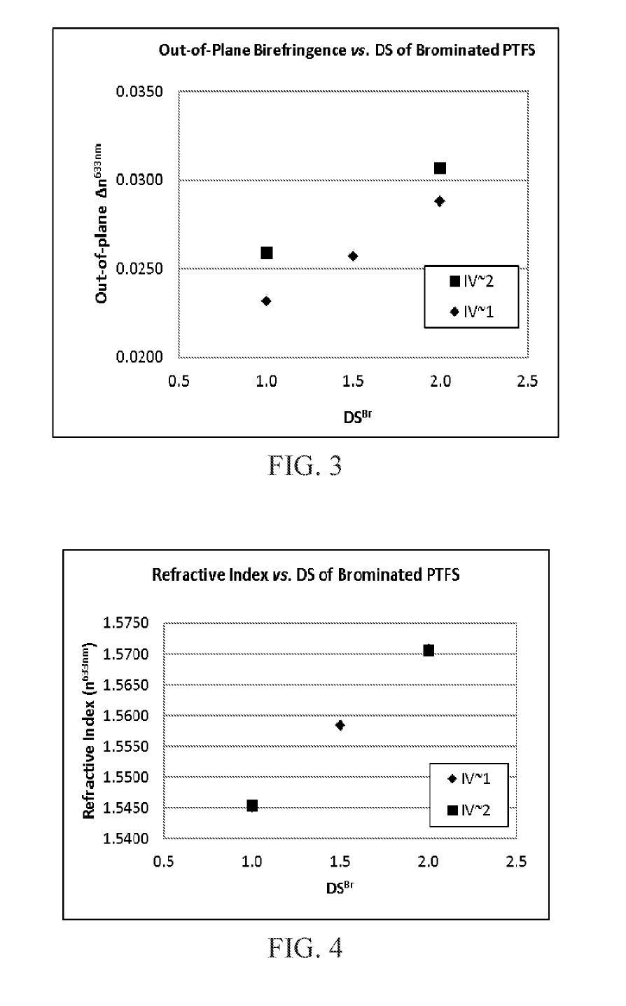

Films 7-11 in Table 4 were thin films prepared from polymers in Table 3 (Polymer 7-11), using methylene chloride (DCM) as the casting solvent. All films were controlled at the thickness of 3.8-4.8 μm for comparison. Based on the results in Table 4, the birefringence and the refractive index were plotted respectively against the degree of substitution in FIG. 3 and FIG. 4, where the two properties increase with increasing DS for the polymers with similar IV. Also, for the same DS, the higher IV polymer has the same refractive index but higher birefringence than the lower IV polymer.

TABLE 4
Optical Properties of Brominated PTFS Films Having
Various Degrees of Substitution

| | | IV, | Casting | | | Thickness, |
|---|---|---|---|---|---|---|
| ID | DS^{Br} | dL/g | Solvent | n^{633 nm} | Δn^{633 nm} | μm |
| Film 7 | 1.0 | 1.13 | DCM | 1.5452 | 0.0232 | 4.8 |
| Film 8 | 1.0 | 2.47 | DCM | 1.5454 | 0.0259 | 4.0 |
| Film 9 | 1.5 | 0.96 | DCM | 1.5584 | 0.0257 | 4.2 |
| Film 10 | 2.0 | 1.07 | DCM | 1.5709 | 0.0288 | 4.0 |
| Film 11 | 2.0 | 1.72 | DCM | 1.5707 | 0.0307 | 3.8 |

### Example 6. Synthesis of 4-Chloro Substituted PTFS (Polymer 12)

To a 100 mL three-neck glass reactor equipped with a nitrogen inlet, a nitrogen outlet, and a mechanical stirrer was charged deionized water (18.470 g). The reactor was submerged in a water bath equipped with a temperature controller. The solution was purged with nitrogen for 30 minutes to remove oxygen. After that, dodecylamine hydrochloride surfactant (0.362 g) was charged to the reactor. The mixture was stirred at 55° C. under nitrogen in order to disperse the surfactant, which was followed by the addition of the monomer, 4-chloro-α,β,β-trifluorostyrene (3.000 g), and the initiator, potassium persulfate (K₂S₂O₈, 0.013 g). The polymerization was allowed to proceed at 55° C. for 24 hours, followed by another addition of K₂S₂O₈ (0.013 g) for 64 hours to yield a homogeneous emulsion. The resulting emulsion was treated in a vacuum oven at 60° C. for 4 hours to yield a crude solid product, which was further purified by washing repeatedly with hot methanol and deionized water. The final product was dried under vacuum to yield a solid polymer. Yield: 80%. Glass transition temperature of the polymer was 218° C. as measured by differential scanning calorimetry (DSC). Intrinsic viscosity (IV) of the polymer was 0.52 dL/g, measured by a Cannon® auto capillary viscometer using N-methyl-2-pyrrolidone (NMP) as the solvent at 30° C. Since the polymer was prepared from monomer, the degree of substitution (DS) of the chloro group in the product was 1.

TABLE 5
Synthesis of 4-Chloro Substituted PTFS

| | | DI | DA | | | | |
|---|---|---|---|---|---|---|---|
| | Cl-TFS, | Water, | HCl, | K₂S₂O₈, | Yield, | IV | |
| ID | g | g | g | g | g | dL/g | DS |
| Polymer 12 | 3.000 | 18.470 | 0.362 | 0.013 × 2 | 2.403 | 0.52 | 1 |

### Example 7. Optical Properties of 4-Chloro Substituted PTFS

Film 12 in Table 6 was a thin film prepared from polymer 12 in Table 5, using cyclopentanone as the casting solvent.

TABLE 6
Optical Properties of Chlorinated PTFS Film

| | | IV, | Casting | | | Thickness, |
|---|---|---|---|---|---|---|
| ID | DS^{Cl} | dL/g | Solvent | n^{633 nm} | Δn^{633 nm} | μm |
| Film 12 | 1 | 0.52 | cyclopentanone | 1.5301 | 0.0221 | 6.8 |

### Comparative Example 8. Synthesis of 4-Methoxy Substituted PTFS

To a 100 mL three-neck glass reactor equipped with a nitrogen inlet, a nitrogen outlet, and a mechanical stirrer was charged &ionized water (30.030 g). The reactor was submerged in a water bath equipped with a temperature controller. The solution was purged with nitrogen for 30 minutes to remove oxygen. After that, dodecylamine hydrochloride surfactant (0.600 g) was charged to the reactor. The mixture was stirred at 55° C. under nitrogen in order to disperse the surfactant, which was followed by the addition of the monomer 4-methoxy-α,β,β-trifluorostyrene (2.777 g) and the initiator, potassium persulfate (K₂S₂O₈, 0.023 g). The polymerization was allowed to proceed at 55° C. for 24 hours, followed by another addition of K₂S₂O₈ (0.023g) for 45 hours to yield a homogeneous emulsion. The resulting emulsion was treated in a vacuum oven at 60° C. for 4 hours to yield a crude solid product, which was further purified by washing repeatedly with hot methanol and deionized water. The final product was dried under vacuum to yield a solid polymer. Yield: 82%. Glass transition temperature of the polymer was 210° C. as measured by DSC. Intrinsic viscosity (IV) of the polymer was 1.11 dL/g, measured by a Cannon® auto capillary viscometer using N-methyl-2-pyrrolidone (NMP) as the solvent at 30° C. Since the polymer was prepared from monomer, the degree of substitution (DS) of the methoxy group in the product was 1.

TABLE 7
Synthesis of 4-Methoxy PTFS

| | MeO- | | DA | | | | |
|---|---|---|---|---|---|---|---|
| | TFS, | DI Water, | HCl, | K₂S₂O₈, | Yield, | IV | |
| ID | g | g | g | g | g | dL/g | DS |
| Comparative | 2.777 | 30.030 | 0.600 | 0.023 × 2 | 2.278 | 1.11 | 1 |
| Polymer 13 | | | | | | | |

### Comparative Example 9. Optical Properties of 4-Methoxy Substituted PTFS Film

Comparative Film 13 in Table 8 was a thin film prepared from comparative polymer 13 in Table 7, using methyl ethyl ketone (MEK) as the casting solvent. This example illustrates the effect of a substituent on the styrenic ring on the birefringence of PITS is unpredictable. In this example, the 4-methoxy substituent has a negative impact on the birefringence of PTFS.

TABLE 8
Optical Properties of 4-Methoxy PTFS Film

| | | IV, | Casting | | | Thickness, |
|---|---|---|---|---|---|---|
| ID | DS^{MeO} | dL/g | Solvent | n^{633 nm} | Δn^{633 nm} | μm |
| Comparative | 1 | 0.52 | MEK | 1.5272 | 0.0182 | 4.7 |
| Film 13 | | | | | | |

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

All percentages, pails, and ratios as used herein are by weight of the total composition, unless otherwise specified. All such weights as they pertain to listed ingredients are based on the active level and, therefore, do not include solvents or by-products that may be included in commercially available materials, unless otherwise specified.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2. 3, 4, 5, 6. 7, 8, 9, and 10) contained within the range.

Any combination of method or process steps as used herein may be performed in any order, unless otherwise specified or clearly implied to the contrary by the context in which the referenced combination is made.

To the extent that the terms “include,” “includes,” or “including” are used in the specification or the claims, they are intended to be inclusive in a manner similar to the term “comprising” as that term is interpreted when employed as a transitional word in a claim. Furthermore, to the extent that the term “or” is employed (e.g., A or B), it is intended to mean “A or B or both A and B.” When the applicants intend to indicate “only A or B but not both,” then the term “only A or B but not both” will be employed. Thus, use of the term “or” herein is the inclusive, and not the exclusive use. In the present disclosure, the words “a” or “an” are to be taken to include both the singular and the plural. Conversely, any reference to plural items shall, where appropriate, include the singular.

In certain embodiments, it may be possible to utilize the various inventive concepts in combination with one another (e.g., one or more of the various embodiments may be utilized in combination with each other). Additionally, any particular element recited as relating to a particularly disclosed embodiment should be interpreted as available for use with all disclosed embodiments, unless incorporation of the particular element would be contradictory to the express terms of the embodiment. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

What is claimed is:

1. An optical compensation film composition comprising a positive birefringent polymer film and a substrate, wherein the polymer film is a positive C-plate and has a positive birefringence greater than 0.02 throughout the wavelength range of 400 nm<λ<800 nm, the polymer film having been cast from a polymer solution comprising a solvent and a polymer having a styrenic moiety of: 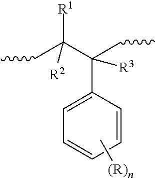
wherein R¹, R², and R³ are each independently hydrogen atoms, alkyl groups, substituted alkyl groups, or halogens, wherein at least one of R¹, R², and R³ is a fluorine atom, wherein R is each independently a substituent on the styrenic ring, and wherein n is an integer from 1 to 5 representing the number of the substituents on the styrenic ring.

2. The optical compensation film composition of claim 1, wherein at least two of R¹, R², and R³ are fluorine atoms.

3. The optical compensation film composition of claim 1, wherein le and R³ are fluorine atoms.

4. The optical compensation film composition of claim 1, wherein the substituent R is selected from the group consisting of fluoro, chloro, bromo, iodo, nitro, phenyl, cyano, trifluoromethyl, and combinations thereof.

5. The optical compensation film composition of claim 1, wherein the substituent R is nitro.

6. The optical compensation film composition of claim 1, wherein the polymer film has a positive birefringence greater than 0,023 throughout the wavelength range of 400 nm<λ<800 nm.

7. The optical compensation film composition of claim 1, wherein the polymer film has a positive birefringence greater than 0.025 throughout the wavelength range of 400 nm<λ<800 nm.

8. The optical compensation film composition of claim 1, wherein the polymer film has a positive birefringence greater than 0.027 throughout the wavelength range of 400 nm<λ<800 nm.

9. The optical compensation film composition of claim 1, wherein the polymer film has a positive birefringence greater than 0.03 throughout the wavelength range of 400 nm<λ<800 nm.

10. The optical compensation film composition of claim 1, wherein the polymer film has a positive birefringence greater than 0.022 and the substituent R on the styrenic ring is selected from the group consisting of bromic, nitro, and combinations thereof.

11. The optical compensation film composition of claim 1, wherein the polymer is poly(α,β,β-trifluorostyrene) with the substituent R on at least one of the styrenic rings.

12. The optical compensation film composition of claim 11, wherein the substituent R is selected from the group consisting of fluoro, chloro, bromo, iodo, nitro, phenyl, cyano, trifluoromethyl, and combinations thereof.

13. The optical compensation film composition of claim 11, wherein the substituent R is nitro.

14. The optical compensation film composition of claim 1, wherein the polymer film has a positive birefringence greater than 0.023, the polymer is poly(α,β,β-trifluorostyrene), the substituent R on the styrenic ring is bromo, and the degree of substitution of the polymer is greater than 1.

15. The optical compensation film composition of claim 1, wherein the polymer film has a positive birefringence greater than 0.025, the polymer is poly(α,β,β-trifluorostyrene), the substituent R on the styrenic ring is bromo, and the degree of substitution of the polymer is greater than 1.5.

16. The optical compensation film composition of claim 1, wherein the polymer film has a positive birefringence greater than 0.023, the polymer is poly(α,β,β-trifluorostyrene), the substituent R on the styrenic ring is nitro, and the degree of substitution of the polymer is greater than 0.25.

17. The optical compensation film composition of claim 1, wherein the polymer film has a positive birefringence greater than 0.027, the polymer is poly(α,β,β-trifluorostyrene), the substituent R on the styrenic ring is nitro, and the degree of substitution of the polymer is greater than 0,45.

18. The optical compensation film composition of claim 1, wherein the polymer film has a positive birefringence greater than 0.03, the substituent R on the styrenic ring is nitro, the polymer is poly(α,β,β-trifluorostyrene), and the degree of substitution of the polymer is greater than 0.6.

19. The optical compensation film composition of claim 1, wherein the polymer film has a positive birefringence greater than 0.035, the polymer is poly(α,β,β-trifluorostyrene), the substituent R on the styrenic ring is nitro, and the degree of substitution of the polymer is greater than 0.85.

20. The optical compensation film composition of claim 1, wherein the polymer film is cast onto the substrate to form a coating on the substrate.

21. The optical compensation film composition of claim 20, wherein the coating has a thickness of about 1 μm to about 15 μm.

22. The optical compensation film composition of claim 20, wherein the substrate is selected from the group comprising cyclic olefin polymer (COP), polycarbonate, cellulose ester, and polyester.

23. The optical compensation film composition of claim 20, wherein the substrate is an A-plate having a refractive index profile nₓ>n_{y}=n_{z} and an in-plane retardation (Rₑ) of about 50 nm to about 200 nm, and wherein the coating has an out-of-plane retardation (Rₜₕ) of about 60 nm to about 150 nm and a thickness of about 1 μm to about 8 μm.

24. The optical compensation film composition of claim 20, wherein the substrate is a biaxial film having a refractive index profile nₓ>n_{y}>n_{z}, an in-plane retardation (Rₑ) of about 60 nm to about 200 nm, and an out-of-plane retardation (Rₜₕ) of about −100 nm to about −200 nm, and wherein the coating has an out-of-plane retardation (Rₜₕ) of about 60 nm to about 250 nm and a thickness of about 1 μm to about 12 μm.

25. The optical compensation film composition of claim 20, wherein the substrate is a quarter wave plate (QWP) having a refractive index profile nₓ>n_{y}>n_{z}, an in-plane retardation (Rₑ) of about 100 nm to about 200 nm, and an out-of-plane retardation (Rₜₕ) of about −50 am to about −150 nm, and wherein the coating has an out-of-plane retardation (Rₜₕ) of about 60 nm to about 300 nm and a thickness of about 1 μm to about 12 μm.

26. The optical compensation film composition of claim 20, which has an in-plane retardation (Rₑ) of about 100 nm to about 200 nm and an out-of-plane retardation (Rₜₕ) that satisfies the equation of |Rₜₕ|<30 nm throughout the wavelength range of about 400 nm to about 800 nm. and wherein the coating has a thickness of about 1 μm to about 12 μm.

27. The optical compensation film composition of claim 1, wherein the solution-cast polymer film is laminated onto the substrate.

28. The optical compensation film composition of claim 1, wherein the solution-cast polymer film is uniaxially or biaxially stretched and subsequently laminated onto the substrate.

29. The optical compensation film of claim 20, wherein the coated substrate is further uniaxially or biaxially stretched.

30. The optical compensation film composition of claim 1, wherein the polymer is a copolymer comprising said styrenic moiety and the residue(s) of one or more ethylenically unsaturated monomers.

31. The optical compensation film composition of claim 30, wherein the ethylenically unsaturated monomers are selected from the group comprising α,β,β-trifluorostyrene, α,β-difluorostyrene, β,β-difluorostyrene, α-fluorostyrene, and β-fluorostyrene, styrene, methyl acrylate, methyl methacrylate, butyl acrylate, butyl methacrylate, 2-ethylhexyl acrylate, acrylic acid, methacrylic acid, n-methyl styrene, 4-methylstyrene, vinyl biphenyl, acrylonitrile, and isoprene.

32. A circular polarizer comprising a linear polarizer and the optical compensation film composition of claim 20, wherein the substrate is a quarter wave plate (QWP) having a refractive index profile nₓ>n_{y}≧n_{z}, and an out-of-plane retardation (Rₜₕ) of about −50 nm to about −150 nm, and wherein the coating has an out-of-plane retardation (Rₜₕ) of about 60 nm to about 150 nm and a thickness of about 1 μm to about 8 μm.

33. A liquid crystal display comprising the optical compensation film composition of claim 1.

34. An OLED display comprising the optical compensation film composition of claim 1.
